(19) United States
(12) Patent Application Publication
(10) Pub. No.: US 2017/0081883 A1
(43) Pub. Date: Mar. 23, 2017

(54) DOOR LATCH ASSEMBLY

(71) Applicant: Thase Enterprise Co., Ltd., Taipei (TW)

(72) Inventor: Ching Tien LIN, Taipei (TW)

(21) Appl. No.: 14/858,015

(22) Filed: Sep. 18, 2015

(51) Int. Cl. E05B 65/10

(52) U.S. Cl. CPC E05B 65/1073; E05B 65/1093

(57) ABSTRACT

A door latch assembly includes a push bar attached to a door panel and connected to an actuating lever, a latch mechanism is attached to the door panel and includes an actuating element, a housing is attached to the seat panel, a rotary latch member is rotatably attached to the housing for engaging with a keeper member, a sliding member is slidably connected to the actuating lever for selectively locking the rotary latch member to the keeper member and for selectively latching the door panel to the door frame, and for allowing the sliding member to be moved away from the rotary latch member with the actuating lever when the push bar is moved toward the casing.

### BACKGROUND OF THE INVENTION

1. Field of the Invention

The present invention relates to a door latch assembly for a panic exit door, and more particularly to a door latch assembly for a panic exit door including an improved and simplified structure or configuration for allowing the door latch assembly to be easily actuated or operated by the user.

2. Description of the Prior Art

Various kinds of typical door latch assemblies for panic exit doors have been developed and provided for latching or locking the exit doors and comprise a push bar connected or coupled to a door latch assembly for actuating or operating the door latch assembly to lock and release the exit doors.

For example, U.S. Pat. No. 3,614,145 to Zawadzki, U.S. Pat. No. 3,877,262 to Williams, U.S. Pat. No. 4,709,950 to Zortman, U.S. Pat. No. 4,796,931 to Heid, U.S. Pat. No. 5,219,385 to Yeh, U.S. Pat. No. 5,605,362 to Surko, Jr., U.S. Pat. No. 6,009,732 to Haeck et al., and U.S. Pat. No. 6,032,985 to Cutter disclose several of the typical door latch assemblies for panic exit doors and each also comprising a door latch assembly including a latch device for selectively latching or locking an exit door panel to a door frame, and a push bar connected or coupled to the latch device of the door latch assembly for actuating or operating a latch tongue or latch bolt of the door latch assembly to lock and release the exit doors or the like.

However, normally, it takes a great force for forcing or moving the latch tongue or latch bolt of the door latch assembly from the door frame such that the latch tongue or latch bolt of the door latch assembly may not be easily actuated or operated by the user with a decreased force.

The present invention has arisen to mitigate and/or obviate the afore-described disadvantages of the conventional door latch assemblies.

### SUMMARY OF THE INVENTION

The primary objective of the present invention is to provide a door latch assembly including an improved and simplified structure or configuration for allowing the door latch assembly to be easily actuated or operated by the user with less force.

The other objective of the present invention is to provide a door latch assembly including an improved and simplified structure or configuration for allowing the door latch assembly to be easily and quickly assembled by the workers.

In accordance with one aspect of the invention, there is provided a door latch assembly comprising a door panel, a door frame, a keeper member attached to the door frame, a push bar mechanism including a casing attached to the door panel, an actuating lever slidably received in the casing, and a push bar attached to the casing and connected to the actuating lever and for actuating the actuating lever to move relative to the casing, and a latch mechanism including a seat panel attached to the door panel, the seat panel including an opening formed therein, an actuating element rotatably engaged with the opening of the seat panel, the actuating element including an engaging hole formed therein and including a cam member provided thereon, a housing attached to the seat panel, the housing including a compartment formed therein, a rotary latch member rotatably attached to the housing with a pivot axle for selectively engaging with the keeper member, a sliding member slidably received and engaged in the housing and connected to the actuating lever for selectively engaging with the rotary latch member and for selectively locking the rotary latch member to the keeper member and for selectively latching the door panel to the door frame, and for allowing the sliding member to be moved relative to the seat panel and to be moved away from the rotary latch member with the actuating lever when the push bar is moved toward the casing, and thus for allowing the door latch assembly to be easily actuated or operated by the user with less force, and to be easily and quickly assembled by the workers.

The rotary latch member includes a number of ears extended radially and outwardly therefrom for forming a number of notches between the ears and for engaging with the keeper member. The keeper member includes a stopping rod for engaging with the notches of the rotary latch member and for selectively latching or locking the door panel to the door frame with the rotary latch member. The sliding member includes a tongue provided thereon for selectively engaging with the rotary latch member and for selectively latching or locking the rotary latch member to the keeper member.

The sliding member includes a guide slot formed therein, and the seat panel includes a guide stud extended therefrom for slidably engaging with the guide slot of the sliding member and for guiding the sliding member to slide relative to the seat panel and the housing. The latch mechanism includes a guide lever, and guide lever includes an orifice formed therein for engaging with the guide stud and for guiding the sliding member to move relative to the seat panel and the housing.

The sliding member includes a flap extended therefrom and having an aperture formed in the flap for slidably engaging with the guide lever. The seat panel includes a guide channel formed therein, and the sliding member includes a guide pin slidably engaged in the guide channel of the seat panel for guiding and limiting the sliding member to move relative to the seat panel and the housing and toward and away from the rotary latch member.

The push bar mechanism includes a linking device coupled between the push bar and the casing. The linking device includes a bracket secured to the casing, an elbow pivotally mounted to the bracket with a pivot rod, the elbow includes a first end portion pivotally mounted to the push bar with a pivot pole and a second end portion pivotally connected to the actuating lever with a pivot pin for allowing the actuating lever to be moved relative to the casing by the elbow when the elbow is pivoted relative to the bracket and the casing.

The linking device includes a spring biasing member engaged onto the pivot rod and engaged between the elbow and the bracket for biasing and forcing the push bar to move away from the bracket and the casing when the push bar is released. The sliding member includes a cam seat provided therein for engaging with the cam member of the actuating element and for allowing the sliding member to be moved or actuated by the actuating element when the actuating element is rotated relative to the door panel.

The push bar mechanism includes an anchoring device for engaging with the actuating lever. For example, the anchoring device includes a frame mounted to the casing, and the frame includes a guide passage formed therein for slidably engaging with the actuating lever. The anchoring device includes a rotary member rotatably attached to the frame and the casing with a pivot shaft for selectively engaging with the actuating lever and for selectively anchoring or positioning the actuating lever to the casing and the door panel.

The rotary member includes a non-circular engaging bore formed therein for engaging with the pivot shaft which is a non-circular pivot shaft and for allowing the rotary member and the pivot shaft to be rotated in concert with each other. The rotary member includes two curved grooves oppositely formed therein, and two fasteners are slidably engaged in the grooves of the rotary member for guiding and limiting the rotary member to rotate relative to the frame.

The rotary member includes a notch formed therein for selectively engaging with the actuating lever for selectively engaging with the actuating lever, and the actuating lever includes a depression formed therein for slidably engaging with the rotary member. The actuating lever includes a stop member for selectively engaging with the notch of the rotary member and for anchoring the actuating lever to the rotary member.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a door latch assembly for a panic exit door in accordance with the present invention;

FIG. 2 is a top plan schematic view of the door latch assembly;

FIG. 3 is a partial perspective view of the door latch assembly;

FIGS. 4, 5 are enlarged partial perspective views illustrating a push bar mechanism of the door latch assembly;

FIG. 6 is a partial exploded view of the door latch assembly;

FIGS. 7, 8 are partial exploded views of the push bar mechanism of the door latch assembly;

FIG. 9 is another partial exploded view illustrating a latch mechanism for the door latch assembly;

FIG. 10 is a partial perspective view of the latch mechanism for the door latch assembly;

FIGS. 11, 12 are partial top plan schematic views illustrating the operation of the latch mechanism for the door latch assembly;

FIGS. 13, 14 are partial perspective views illustrating the operation of the latch mechanism for the door latch assembly;

FIG. 15 is a further partial exploded view illustrating a catch mechanism for the door latch assembly; and

FIGS. 16, 17 are partial perspective views illustrating the operation of the catch mechanism for the door latch assembly.

### DETAILED DESCRIPTION OF THE PREFERRED EMBODIMENT

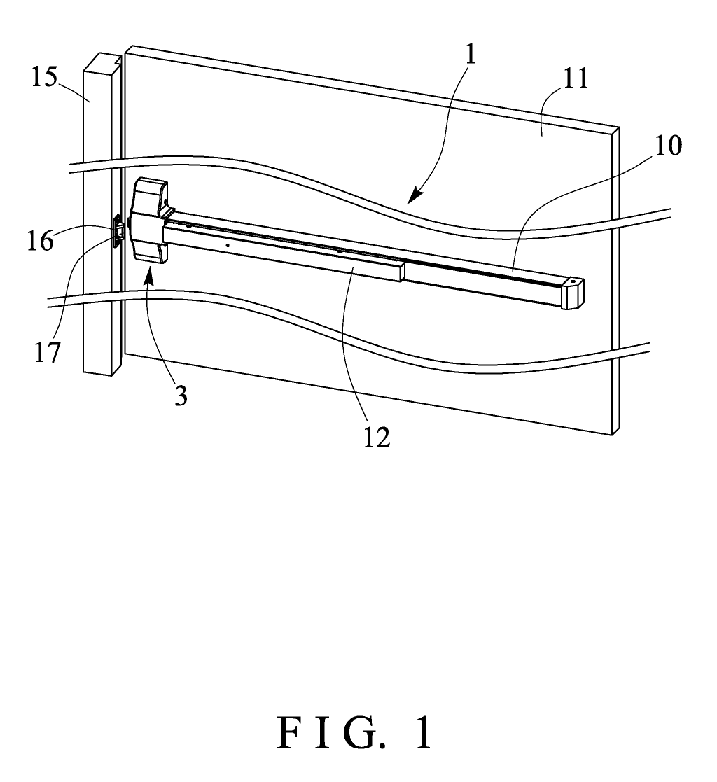

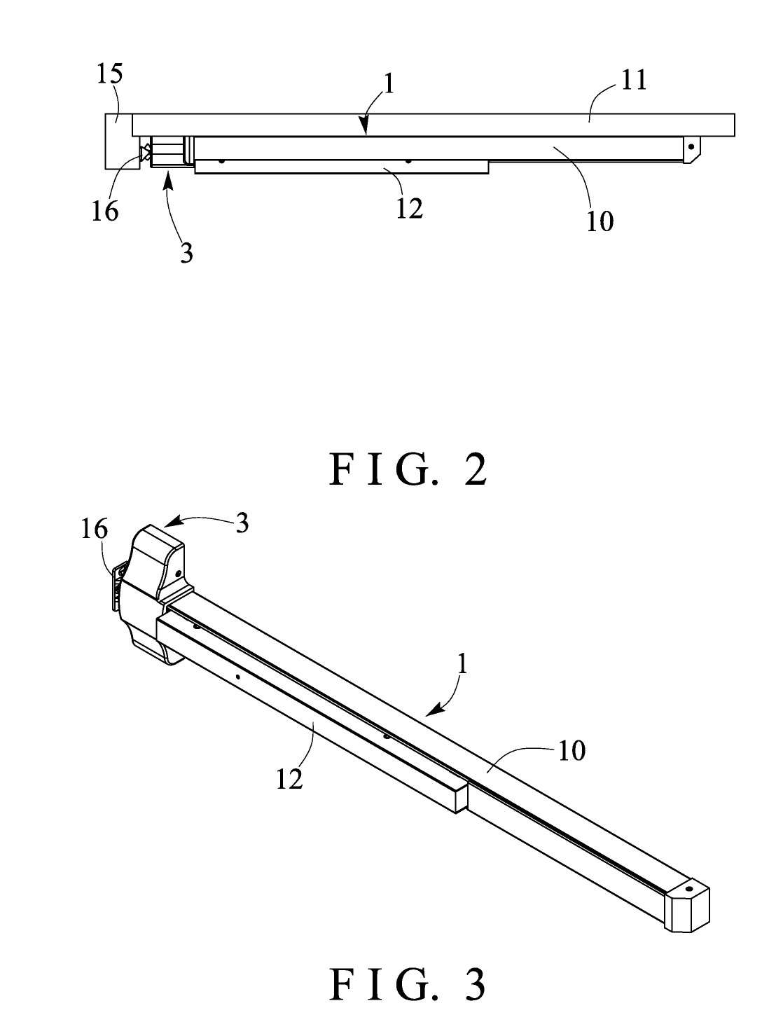

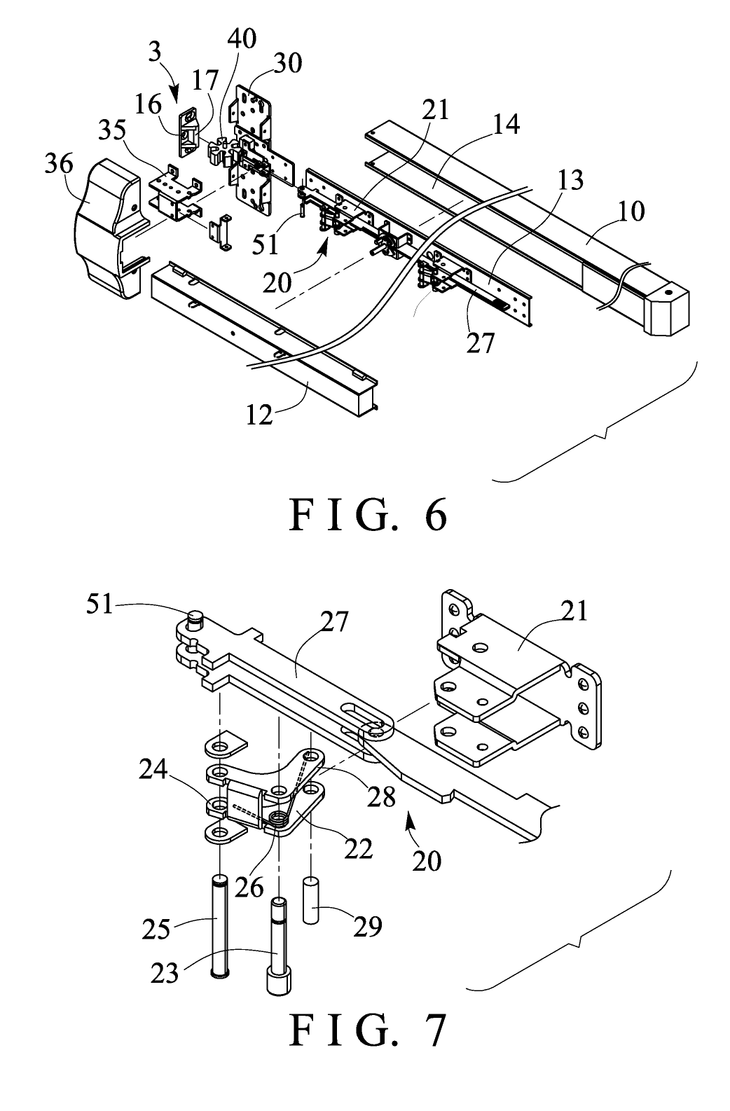

Referring to the drawings, and initially to FIGS. 1-6, a door latch assembly in accordance with the present invention comprises a push bar mechanism 1 including a box or casing 10 attached or mounted to the middle or intermediate portion at an inner or indoor portion of a door panel 11 (FIGS. 1, 2), such as an exit door panel 11, a push bar 12 slidably attached or mounted to the casing 10, and a base plate 13 (FIGS. 6, 16-17) is disposed or engaged into an inner chamber 14 of the casing 10 and mounted or secured to the casing 10 with screws or catches or fasteners (not illustrated) or the like, or formed integral with the casing 10, one or more (such as two) linking devices 20 are connected or coupled between the push bar 12 and the base plate 13 and/or the casing 10.

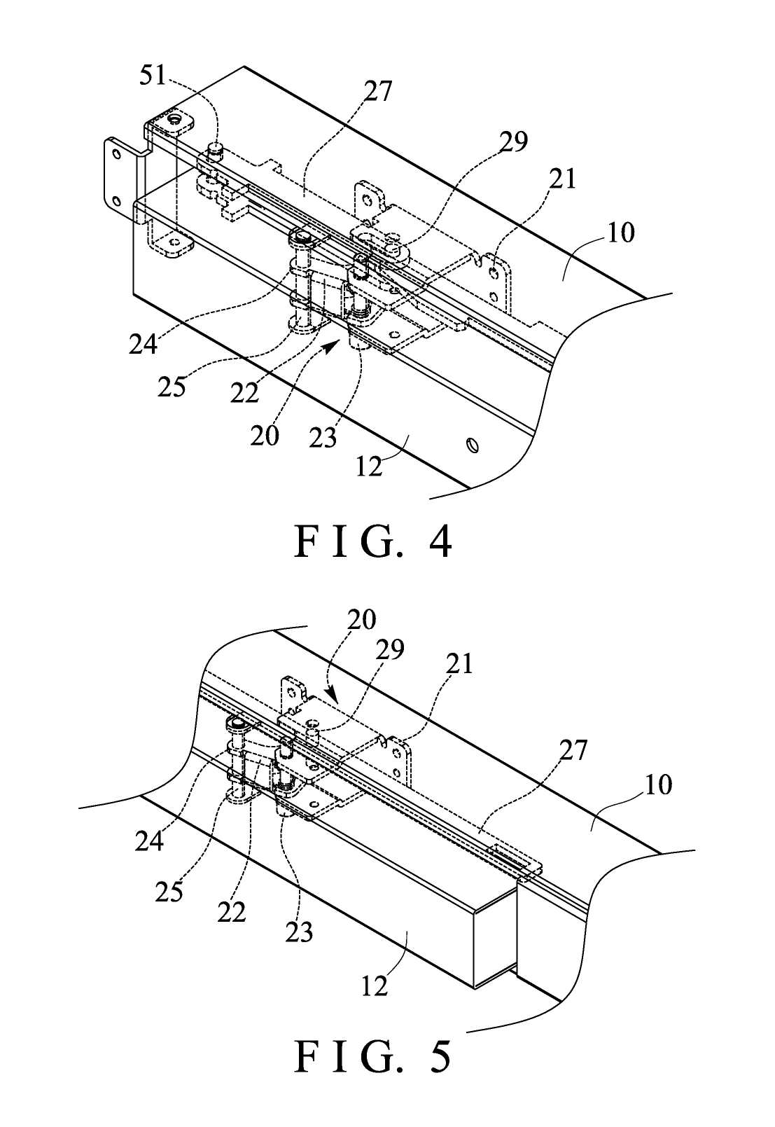

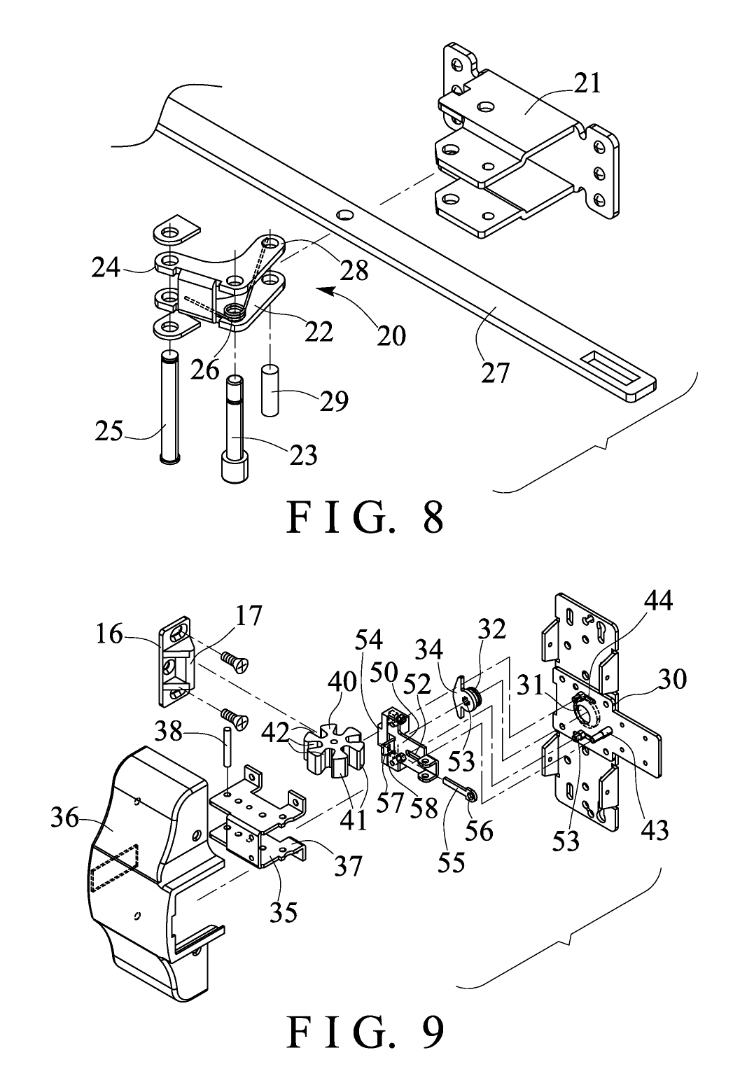

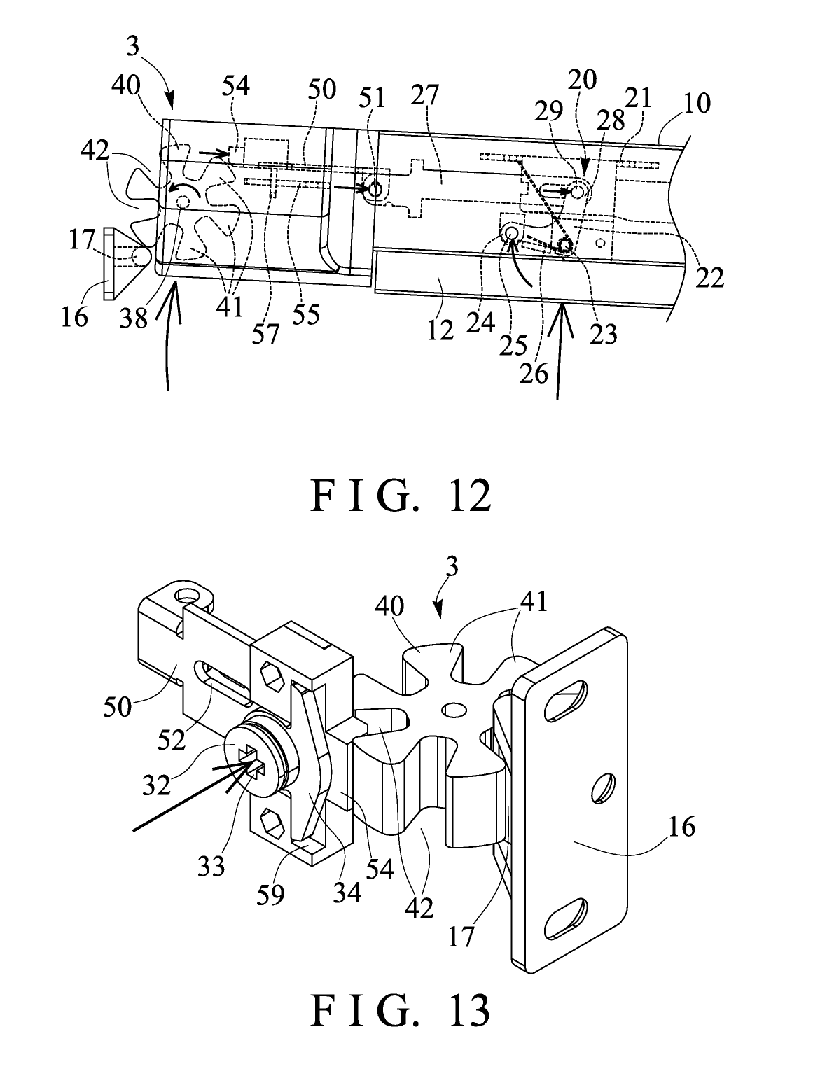

For example, as shown in FIGS. 4-8 and 11-12, the linking devices 20 each include a bracket 21 disposed or engaged into the chamber 14 of the casing 10 and mounted or secured to the casing 10 with catches or fasteners (not illustrated) or the like, an elbow 22 having a middle or intermediate portion pivotally or rotatably attached or mounted to the bracket 21 with a pivot rod 23 for allowing the elbow 22 to be pivoted or rotated relative to the bracket 21 and the casing 10, the elbow 22 includes one or first end portion 24 pivotally or rotatably attached or mounted to the push bar 12 with a pivot pole 25 for allowing the elbow 22 to be pivoted or rotated relative to the bracket 21 and the casing 10 with the push bar 12 when the push bar 12 is forced or pushed toward the bracket 21 and the casing 10 (FIG. 12).

A spring biasing member 26 is attached or mounted to the elbow 22, or engaged onto the pivot rod 23 and contacted or engaged between the elbow 22 and the bracket 21 and/or the casing 10 for biasing and forcing the push bar 12 to move away from the bracket 21 and the casing 10 when the push bar 12 is released (FIG. 11). An actuating lever 27 is slidably received or engaged in the brackets 21, and the other or second end portion 28 of the elbow 22 is pivotally or rotatably connected or coupled to the actuating lever 27 with a pivot pin 29 for allowing the actuating lever 27 to be moved relative to the base plate 13 and the casing 10 longitudinally or axially with or by the elbow 22 when the elbow 22 is pivoted or rotated relative to the bracket 21 and the casing 10.

As shown in FIGS. 1-3, 6 and 9-12, a latch mechanism 3 is to be attached or mounted to the door panel 11 and preferably arranged or located at the inner or indoor portion of the door panel 11 and disposed and arranged or located on one side or one end portion of the casing 10, and disposed and arranged or located beside or close to the door frame 15 for selectively contacting or engaging with a stopping rod 17 of a latching or keeper member 16 (FIGS. 6, 9, 11-14) and for selectively latching or locking the door panel 11 to the door frame 15. The above-described structure or configuration for the push bar mechanism 1 and the keeper member 16 is typical and is not related to the present invention and will not be described in further details.

As shown in FIGS. 6 and 9-12, the latch mechanism 3 includes a seat panel 30 attached or mounted or secured to the door panel 11 with screws or catches or fasteners (not illustrated) or the like, and the seat panel 30 includes an opening 31 formed therein for pivotally or rotatably receiving or engaging with a rotary member or actuating element 32, the actuating element 32 includes a non-circular engaging hole 33 formed therein (FIGS. 9, 13-14) for engaging with a correct or selected key (not illustrated) or the like and for allowing the actuating element 32 to be pivoted or rotated relative to the door panel 11 and the seat panel 30 with or by the selected key. The actuating element 32 includes a curved or convex guide or cam surface or cam member 34 formed or provided thereon.

A housing 35 and/or a cover 36 are attached or mounted to the inner or indoor portion of the door panel 11, and mounted or secured to the seat panel 30 with screws or catches or fasteners (not illustrated) or the like, and the housing 35 includes a compartment 37 formed therein for pivotally or rotatably receiving or engaging with a rotary latch member 40, for example, the rotary latch member 40 is partially and pivotally or rotatably received or engaged in the compartment 37 of the housing 35 and pivotally or rotatably attached or mounted to the housing 35 with a pivot axle 38, and the rotary latch member 40 includes a number of fingers or ears 41 extended radially and outwardly therefrom for forming or defining a number of depressions or notches 42 therein and between the ears 41 and for engaging with the stopping rod 17 of the keeper member 16 (FIGS. 11-14) and for selectively latching or locking the door panel 11 to the door frame 15.

A follower or sliding member 50 is slidably received or engaged in the housing 35 and pivotally connected or coupled to the actuating lever 27 with a pivot pin or connecting pin 51 (FIGS. 6, 11-12) for allowing the sliding member 50 to be moved relative to the housing 35 and the base plate 13 and the casing 10 longitudinally or axially with or by the actuating lever 27 and the elbows 22 when the elbows 22 are pivoted or rotated relative to the bracket 21 and the casing 10 with the push bar 12. As shown in FIG. 9, the sliding member 50 includes a guide slot 52 formed therein, and the seat panel 30 includes a guide stud 43 extended therefrom for slidably engaging with the guide slot 52 of the sliding member 50 and for guiding the sliding member 50 to slide or move relative to the seat panel 30 and the housing 35.

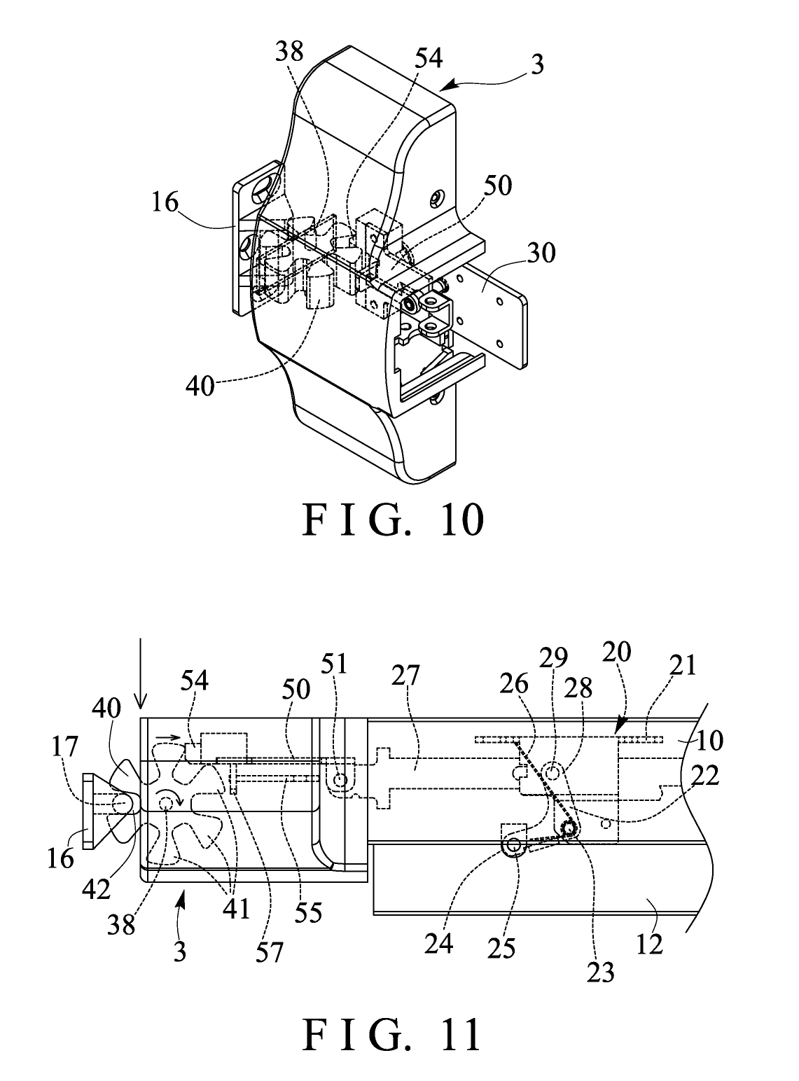

The seat panel 30 may further include one or more (such as two) guide channels 44 formed therein, and the sliding member 50 includes one or more (such as two) guide pins 53 mounted or secured thereto and slidably received or engaged in the guide channels 44 of the seat panel 30 respectively for further guiding the sliding member 50 to slide or move relative to the seat panel 30 and the housing 35 and for further guiding the sliding member 50 to move toward or away from the rotary latch member 40. The sliding member 50 includes a tongue 54 formed or provided thereon for selectively contacting or engaging with the rotary latch member 40 (FIGS. 10-14) and for selectively latching or locking the rotary latch member 40 to the keeper member 16 (FIGS. 11, 13) and thus for selectively latching or locking the door panel 11 to the door frame 15.

In operation, as shown in FIGS. 11, 12, when the push bar 12 is pushed toward the casing 10 and to move the actuating lever 27 rightwardly, the actuating lever 27 which is contacted or engaged with the sliding member 50 may actuate or move the sliding member 50 rightwardly relative to the housing 35 and the casing 10, and may pull or move the sliding member 50 away from the rotary latch member 40 and thus may release the sliding member 50 for allowing the tongue 54 of the sliding member 50 to be selectively disengaged or separated from the rotary latch member 40 (FIG. 12), and thus for allowing the rotary latch member 40 to be pivoted or rotated relative to the housing 35 and the door panel 11, and thus for allowing the door panel 11 to be released or opened relative to the door frame 15 from indoors with the push bar 12.

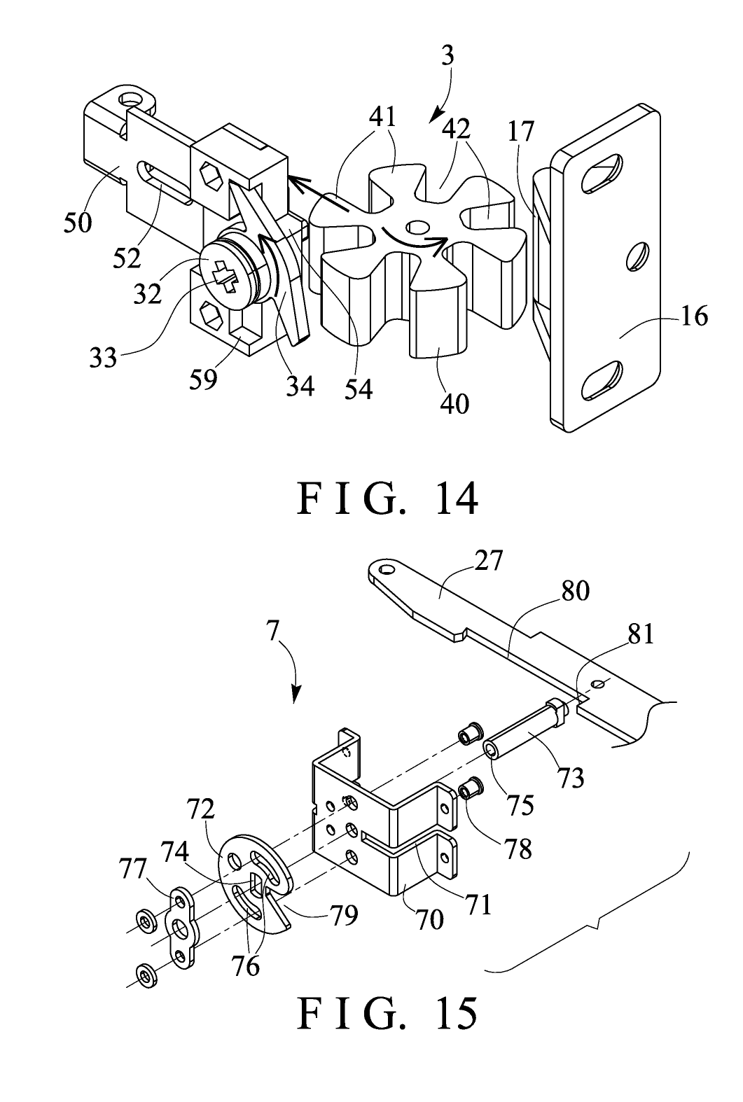

A guide lever 55 may further be provided and includes an orifice 56 formed therein for receiving or engaging with the guide stud 43, and the sliding member 50 includes a flap 57 extended therefrom and having an aperture 58 formed therein for slidably receiving or engaging with the guide lever 55 and for further guiding the sliding member 50 to move relative to the seat panel 30 and the housing 35 and for further guiding the sliding member 50 to move toward or away from the rotary latch member 40. As shown in FIGS. 13-14, the sliding member 50 includes a guide or cam seat 59 formed or provided therein for engaging with the cam member 34 of the actuating element 32 and for allowing the sliding member 50 to be selectively actuated or moved relative to the housing 35 with or by the actuating element 32 from the outer or outdoor portion of the door panel 11.

As shown in FIGS. 15-17, a latching or catching or anchoring device 7 may further be provided and includes a frame 70 mounted or secured to the base plate 13 and the casing 10 with screws or catches or fasteners (not illustrated) or the like, and the frame 70 includes a guide passage 71 laterally formed therein for slidably receiving or engaging with the actuating lever 27, a rotary member 72 is pivotally or rotatably attached or mounted to the frame 70 and the base plate 13 and the casing 10 with a pivot shaft 73, and the rotary member 72 includes a non-circular engaging hole or bore 74 formed therein for engaging with the corresponding non-circular pivot shaft 73 and for allowing the rotary member 72 and the pivot shaft 73 to be pivoted and rotated in concert with each other. The pivot shaft 73 includes an engaging hole 75 formed in the free end portion of the pivot shaft 73 for selectively engaging with a screw driver or tool member (not illustrated) or the like that may be used for selectively rotating the pivot shaft 73 and the rotary member 72 relative to the frame 70. The rotary member 72 includes one or more (such as two) curved grooves 76 oppositely formed therein.

A retaining bar or element 77 is mounted or secured to the frame 70 with one or more (such as two) rivets or fasteners 78, and contacted or engaged with the rotary member 72 for allowing the rotary member 72 to be solidly and stably anchored or retained or positioned between the frame 70 and the retaining element 77 and for preventing the rotary member 72 from being disengaged or separated from the frame 70. The fasteners 78 are slidably received or engaged in the grooves 76 of the rotary member 72 for guiding or limiting the rotary member 72 to smoothly pivot and rotate relative to the frame 70. The rotary member 72 further includes a notch 79 formed therein. The actuating lever 27 includes a recess or depression 80 formed therein for slidably receiving or engaging with the rotary member 72, and includes a stop member 81 formed or defined or provided on one side of the depression 80 of the actuating lever 27.

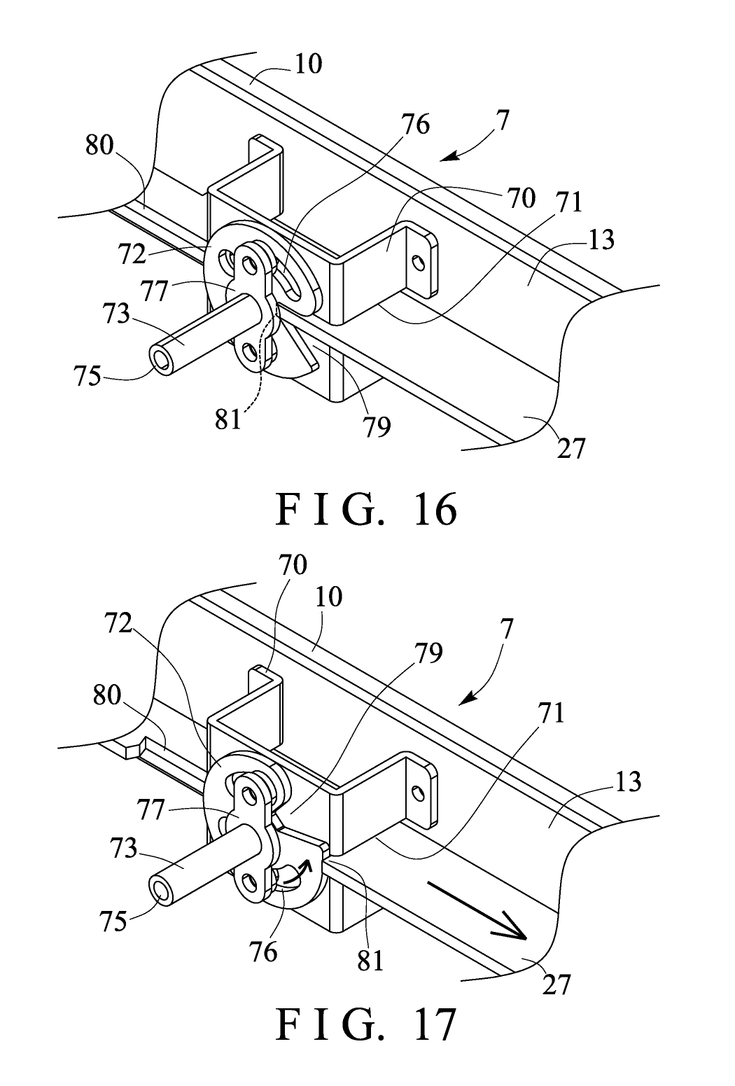

In operation, as shown in FIG. 16, when the notch 79 of the rotary member 72 is aligned with the guide passage 71 of the frame 70, the stop member 81 of the actuating lever 27 may be moved and engaged into the notch 79 of the rotary member 72, at this moment, the actuating lever 27 is allowed to slide or move leftwardly toward the latch mechanism 3. On the contrary, as shown in FIG. 17, when the notch 79 of the rotary member 72 is offset or spaced or disengaged from the guide passage 71 of the frame 70, the stop member 81 of the actuating lever 27 may not be moved and engaged into the notch 79 of the rotary member 72, at this moment, the actuating lever 27 is not allowed to slide or move leftwardly toward the latch mechanism 3 and thus may not move the sliding member 50 relative to the seat panel 30 and the housing 35, and such that the sliding member 50 may not be moved toward the rotary latch member 40 by the actuating lever 27, and such that the rotary latch member 40 may not be locked to the keeper member 16.

Accordingly, the door latch assembly in accordance with the present invention includes an improved and simplified structure or configuration for allowing the door latch assembly to be easily actuated or operated by the user.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A door latch assembly comprising:
a door panel,
a door frame,
a keeper member attached to said door frame,
a push bar mechanism including:
a casing attached to said door panel,
an actuating lever slidably received in said casing, and
a push bar attached to said casing and connected to said actuating lever and for actuating said actuating lever to move relative to said casing, and
a latch mechanism including:
a seat panel attached to said door panel, said seat panel including an opening formed therein,
an actuating element rotatably engaged with said opening of said seat panel, said actuating element including an engaging hole formed therein and including a cam member provided thereon,
a housing attached to said seat panel, said housing including a compartment formed therein,
a rotary latch member rotatably attached to said housing with a pivot axle for selectively engaging with said keeper member,
a sliding member slidably received and engaged in said housing and connected to said actuating lever for selectively engaging with said rotary latch member and for selectively locking said rotary latch member to said keeper member and for selectively latching said door panel to said door frame, and for allowing said sliding member to be moved relative to said seat panel and to be moved away from said rotary latch member with said actuating lever when said push bar is moved toward said casing.

2. The door latch assembly as claimed in claim 1, wherein said rotary latch member includes a plurality of ears extended radially and outwardly therefrom for forming a plurality of notches between said ears and for engaging with said keeper member.

3. The door latch assembly as claimed in claim 2, wherein said keeper member includes a stopping rod for engaging with said notches of said rotary latch member.

4. The door latch assembly as claimed in claim 1, wherein said sliding member includes a tongue provided thereon for selectively engaging with said rotary latch member and for selectively locking said rotary latch member to said keeper member.

5. The door latch assembly as claimed in claim 1, wherein said sliding member includes a guide slot formed therein, and said seat panel includes a guide stud extended therefrom for slidably engaging with said guide slot of said sliding member and for guiding said sliding member to slide relative to said seat panel and said housing.

6. The door latch assembly as claimed in claim 5, wherein said latch mechanism includes a guide lever, and guide lever includes an orifice formed therein for engaging with said guide stud and for guiding said sliding member to move relative to said seat panel and said housing.

7. The door latch assembly as claimed in claim 6, wherein said sliding member includes a flap extended therefrom and having an aperture formed in said flap for slidably engaging with said guide lever.

8. The door latch assembly as claimed in claim 1, wherein said seat panel includes a guide channel formed therein, and said sliding member includes a guide pin slidably engaged in said guide channel of said seat panel for guiding said sliding member to move relative to said seat panel and said housing.

9. The door latch assembly as claimed in claim 1, wherein said push bar mechanism includes a linking device coupled between said push bar and said casing.

10. The door latch assembly as claimed in claim 9, wherein said linking device includes a bracket secured to said casing, an elbow pivotally mounted to said bracket with a pivot rod, said elbow includes a first end portion pivotally mounted to said push bar with a pivot pole and a second end portion pivotally connected to said actuating lever with a pivot pin for allowing said actuating lever to be moved relative to said casing by said elbow when said elbow is pivoted relative to said bracket and said casing.

11. The door latch assembly as claimed in claim 10, wherein said linking device includes a spring biasing member engaged onto said pivot rod and engaged between said elbow and said bracket for biasing and forcing said push bar to move away from said bracket and said casing.

12. The door latch assembly as claimed in claim 1, wherein said sliding member includes a cam seat provided therein for engaging with said cam member of said actuating element.

13. The door latch assembly as claimed in claim 1, wherein said push bar mechanism includes an anchoring device for engaging with said actuating lever.

14. The door latch assembly as claimed in claim 13, wherein said anchoring device includes a frame mounted to said casing, and said frame includes a guide passage formed therein for slidably engaging with said actuating lever.

15. The door latch assembly as claimed in claim 14, wherein said anchoring device includes a rotary member rotatably attached to said frame and said casing with a pivot shaft for selectively engaging with said actuating lever.

16. The door latch assembly as claimed in claim 15, wherein said rotary member includes a non-circular engaging bore formed therein for engaging with said pivot shaft which is a non-circular pivot shaft and for allowing said rotary member and said pivot shaft to be rotated in concert with each other.

17. The door latch assembly as claimed in claim 15, wherein said rotary member includes two curved grooves oppositely formed therein, and two fasteners are slidably engaged in said grooves of said rotary member for guiding and limiting said rotary member to rotate relative to said frame.

18. The door latch assembly as claimed in claim 15, wherein said rotary member includes a notch formed therein, and said actuating lever includes a depression formed therein for slidably engaging with said rotary member.

19. The door latch assembly as claimed in claim 18, wherein said actuating lever includes a stop member for selectively engaging with said notch of said rotary member.
